(19) United States
(12) Patent Application Publication
(10) Pub. No.: US 2007/0156707 A1
(43) Pub. Date: Jul. 5, 2007

(54) Device and method for access to information which relates to at least one medicament

(76) Inventors: Friedrich Fuchs, Rottenbach (DE); Sean Harrison, Herzogenaurach (DE); Robert Kagermeier, Nurnberg (DE); Rainer Kuth, Hochstadt (DE); Klaus Ludwig, Nurnberg (DE); Dietmar Sierk, Erlangen (DE); Gerhard Weller, Erlangen (DE)

Correspondence Address: HARNESS, DICKEY & PIERCE, P.L.C., P.O.BOX 8910, RESTON, VA, 20195, US

(21) Appl. No.: 11/640,971

(22) Filed: Dec. 19, 2006

(30) Foreign Application Priority Data
Dec. 20, 2005 (DE) 10 2005 061 004.8

(51) Int. Cl. G06F 17/30

(52) U.S. Cl. 707/10

(57) ABSTRACT

A device and a method are disclosed for access to at least one information item, which relates to at least one medicament, by a user, in particular in a hospital. At least one mobile electronic appliance is provided for carrying by the user. The appliance includes a reading device which is designed for reading an electronically legible identification which identifies the medicament. The mobile appliance includes a data link to at least one appliance-internal and/or -external memory device in which the information relating to the medicament is stored in such a manner that it is made available to the user via the mobile appliance as a function of the reading of the electronically legible identification of the medicament.

### PRIORITY STATEMENT

The present application hereby claims priority under 35 U.S.C. §119 on German patent application number DE 10 2005 061 004.8 filed Dec. 20, 2005, the entire contents of which is hereby incorporated herein by reference.

### FIELD

Embodiments of the invention generally relate to a device and/or a method for access to at least one information item, which relates to at least one medicament, by a user, in particular in a hospital.

### BACKGROUND

Doctors, nurses and other people who, for example, work in a hospital or in a clinical facility often require, both there and elsewhere, rapid access to a wide range of information relating to medicaments to be administered or to medicaments which have already been ordered. This information includes, inter alia, information about characteristics of the medicaments, about indications and contra-indications, about risks and about possible incompatibilities, dosage recommendations and details relating to storage conditions. Furthermore, information relating to possible alternative medicaments may likewise be helpful, such as information relating to the costs of an administered dose. Furthermore, a doctor who has ordered a corresponding medicament requires information relating to its availability in the hospital or to the conditions and authorizations for orders and the like.

Until now, information such as this has been obtained, in some cases with unavoidable gaps, by looking at appropriate books and documents. In some cases, modern hospitals have fixed electronic data viewing stations and which, however, only a portion of the medicament-related information is provided for being called up at a fixed location.

In these existing systems, which are based on a large number of media such as books and documents or else viewing stations, one problem which arises is that the amount of time which is required for search processes is often very long and is no longer acceptable. The search processes must be carried out predominantly manually in which case, in particular in the case of printed media, one problem that always arises is that the information which is accessible at all in this way is not provided in its up-to-date version. In particular, especially when using printed works, it is virtually impossible to provide protection for access to information. Even in the case of electronic systems which are used only by individuals, access protection is possible only with a high degree of complexity, and to a restricted extent.

One problem that therefore generally arises is that information is poorly protected and, furthermore, is not accessible sufficiently quickly, since it must be tediously searched for from widely differing information systems and media. It is therefore impossible to proclude the possibility, particularly in cases in which a rapid reaction is required, for example in the event of an emergency, of medication not being provided optimally for the patient or of it not being possible to obtain the required medicament so that, in some circumstances, the patient is treated with an unsuitable medicament, in the wrong dosage and/or with side effects which are dangerous to that patient.

EP 1 422 649 A2 describes a method for medicament consumption or application monitoring. In this case, a patient or a subject for a medicament supplies associated, machine-legible information, which identifies the nature of the medicament, to a recording device. In this case, the medicament-specific data coming from the recording device is stored, coupled with its recording times, and can thus easily be read for research purposes.

U.S. Pat. No. 5,781,442 describes a supervision administration system for hospitals.

WO 2004/036481 A2 describes an integrated pharmacy system for dealing with electronic prescriptions. In this case, a prescription is received, a substitute medicament is selected if appropriate, the payment is controlled, and the transaction is archived.

### SUMMARY

In at least one embodiment of the invention, a device is specified which is better than the prior art and/or a method is specified which is better than the prior art for access to at least one information item, which is related to at least one medicament, by a user, in particular in a hospital.

In at least one embodiment, the invention provides that at least one mobile electronic appliance is provided for carrying by the user which appliance has a reading device which is designed for reading an electronically legible identification which identifies the medicament, with the mobile appliance having a data link to at least one appliance-internal and/or -external memory device in which the information relating to the medicament is stored in such a manner that it is made available to the user via the mobile appliance as a function of the reading of the electronic identification.

According to at least one embodiment of the invention, the device thus has one or more mobile electronic appliances, generally a multiplicity of mobile electronic appliances, which are carried by respective users, such as doctors or nurses. The mobile electronic appliances have reading devices, that is to say for example readers, which are suitable for reading electronic identifications, with this expression in general being understood as meaning electronically legible identifications, that is to say identifications which can be read, for example, by a laser system or radio system.

The reading process can be carried out actively or passively, without any actions by the user. The medicaments for which information is available are characterized by electronically legible identifications, for which purpose these identifications are applied to the medicament, that is to say for example to a medicament container or a surrounding packaging or, possibly, removably directly on the preparation. The electronic identifications may for this purpose, by way of example, be adhesively bonded to a package or printed on it, or may be incorporated in a package, or may just be attached in the vicinity of the medicament or in a medicament bag which is associated with a specific patient.

The users, who are generally numerous, may be doctors, nurses, medical-technical personnel and those working in a hospital's own pharmacy and further service facilities. The expression “hospital” should in this case be understood in the widest sense, that is to say as a hospital group, a clinic facility or a medical service center or the like, in which case a hospital such as this may in fact comprise a plurality of buildings or complexes which are physically separate from one another.

The mobile electronic appliance, referred to for short in the following text as a mobile appliance, which the user or users carries or carry with him, her or them, is connected to a memory device via a suitable data link, which advantageously does not use cables, in which memory device the information relating to the medicament or medicaments is stored. The memory device with the medicament information may in this case be a component of the mobile appliance, although it is advantageously an external memory device for example of a central point in the hospital, in which all of the information which relates to medicaments is stored centrally and/or as appropriate memory and access locations. If required, the information can be stored in both memory devices or in a plurality of memory devices, be they internal or external to the appliance.

When the user now uses his mobile appliance to read the electronic identification which identifies the medicament, he receives at least one information item which is related to that medicament, for example the name, information relating to side effects and incompatibilities and the like.

Reading in the electronically legible identification results in medicament-related information being provided quickly and with errors being virtually completely precluded. For this purpose, the device is based on three fundamental principles, which are formed on the one hand by the medicament with the electronic identification, secondly by the memory device and an associated programming application, and finally by the mobile appliance with its reading device.

The device may have a computer apparatus with an external memory device, in particular at least one central server with a central memory device and/or workstation computer. A central memory device is advantageously provided outside the mobile appliance in a computer apparatus which ensures for numerous users that the data is available to all users with the same currency status. Central data storage such as in a computer apparatus which may be formed by one or more servers with associated clients and workstation computers optimizes the memory utilization by avoiding data being held in a duplicated form, while at the same time allowing simple maintenance of the database, for example using databank structures.

The in particular central memory device and/or computer apparatus may be part of an external information system and/or procedure control, in particular part of a hospital information system. In this case, the fundamental principle of the device according to the invention which is located between the electronic identification of the medicament and the reading device for identification is formed by a part of a central information system which, for data purposes, accompanies the operation, the administration and the processes in a hospital or in a clinical facility.

The user and/or a patient and/or a location has at least one further associated identification which can be read electronically by the reading device of the mobile appliance, or this user and/or patient and/or location is provided with such an identification, in which case the user and/or a patient and/or a location can be identified and/or can be associated with a group via the identification. For example, a doctor can carry an electronically legible identification with him in order to identify himself to software which is provided on the mobile appliance or from a central computer apparatus and which then allocates specific authorizations to the doctor and associates him with the group of doctors, and/or identifies him personally.

In the same way, when an identification is read in for the patient who is carrying this device with him or for whom the device is arranged in the patient's room, on his bed or on his bedside locker, the patient is identified with his name, specific illnesses and treatments to be carried out, in which case it is possible to produce links between the reading in of the further identifications and the reading in of the identification of the medicament. The identifying information is kept available, for example, in a central databank, with logic linking rules etc., also being kept available in the central memory device or databank. The electronic identifications are read in quickly, avoiding the need to make inputs by hand or entries on paper, thus avoiding previous error sources.

The information or the plurality of information items can be made available to the user as a function of the reading of the further electronic identification. By way of example, it is possible to make available or to display information which relates to side effects or contra-indications of a medicament as a function of the reading of the identification of the patient with reference to the illnesses being suffered by the patient, and taking into account the patient's gender and age. It is thus possible to display the information which is relevant for the respective patient with respect to the relevant medicament in a clear form to a doctor or to a nurse.

It is, of course, feasible to read a plurality of further identifications for provision purposes so that, for example, it is possible to display other information to a doctor in conjunction with the reading of the identification of the patient and of the medicament than, for example, to a medical technical assistant who is not responsible for all of the treatment but who intends to carry out a specific examination on the patient.

The device according to at least one embodiment of the invention thus makes it possible to display information in a clear form and without any additional user inputs. There is no need for active operations, which are always associated with a risk of errors.

The reading of location-related identifications, for example in the entry area to a room, makes it possible to obtain a position reference for the medicament information, for example in such a manner that this identifies that a specific medicament is available or no longer available in a medicament room. The position reference likewise makes it possible to identify a relationship with a specific patient.

The electronically legible identification may be a bar code and/or an RFID transponder and/or a further identification which could be read without contact being made. These identifications in particular allow identification of the respective medicament, in which, by way of example, an RFID transponder offers the advantage that the reading process does not necessitate any active operation by the user, but is carried out automatically as a function of signals of the reading device. In addition, the RFID technology (RFID Radio-Frequency Identification) makes it possible, at least when using transponders with their own power supply, to transmit data over a relatively long distance, or with extended functionalities. For example, this makes it possible to store more information in a larger available memory space than on a bar code, which must first of all be scanned in.

At least one electronically legible identification may be in the form of a label and/or a chip and/or identification device which can be worn and/or carried on the body, in particular in the form of a pass and/or armband. For example, the passive subscribers and components of the device, that is to say patients and identified locations etc., can thus wear armbands as people and, as objects, can be provided with chips or labels. In the case of active subscribers such as doctors or technical personnel and/or nurses, pass cards and chips or the like, for example, can be provided, which such people carry with them in any case for identification, for example in order to allow other functions such as access to specific secure areas and the like.

At least one memory device and/or, possibly, the computer apparatus may be designed for, in particular continuous, recording of reading-related data, in particular by association with a time stamp, and/or for further processing of reading-related data, in particular by linking data and/or inputs to the mobile appliances and/or stored data and/or information. For example, a continuous record of the processes that take place in the hospital or in the clinical facility can thus expediently be stored in a central computer apparatus. In this case, possibly all of the data which is related to the reading of identifications, such as the time and/or the reading appliance, as well as identifications which are likewise recorded in real time, are stored at least for a specific time.

It is thus possible to tell at any time who, for example which doctor, was at a specific location and at a specific time, and what actions were carried out there. For example, it is possible to check whether a nurse has carried out a check on a patient or in a specific patient's room, and/or whether a doctor has checked the presence of the medicaments for a patient. Furthermore, extensive data processing can be carried out, for example by the selection of information as a function of a data link, and this processing is carried out on the basis of reading in a specific combination of electronic identifications, for example for a specific location and for a specific doctor.

The information relating to the reading of identifications can also be linked to inputs which can be made by a user to the mobile appliance, for example in such a manner that a user uses a clearly structured menu on a display on the mobile appliance to select a menu item which provides further information relating to a patient and/or to the medicament. The recording need not be carried out continuously but can also be carried out by a matching process at specific time intervals, in which case, if necessary, it is accepted that the recording will be less accurate if the mobile appliance does not allocate its own time stamp. However, the recording in a memory device which is accessible everywhere is advantageously carried out continuously in order to keep the database up-to-date for all users.

According to at least one embodiment of the invention, medicament-related processes can be initiated as a function of the reading of at least one electronic identification, in particular of a user, via a computer apparatus, in particular ordering processes and/or monitoring processes and/or billing processes, and/or information can be stored in the memory device. For example, when reading in a medicament identification, it is possible to initiate the reordering of the medicament, possibly in conjunction with the selection of a specific menu item by a doctor who has identified himself electronically. For this purpose, if appropriate, the user can select information relating to the medicament, for example relating to the package size, with this information being provided visually and/or audibly on the mobile appliance, or else the reading in of the identification initiates an ordering process with the original package size which is obtained, for example, in a coded form by the identification. The electronic identifications allow reliable identification of whatever initiates a specific process, at all times.

The medicament-related processes can be initiated as a function of authorizations which can be determined by reading electronically legible identifications, in particular as a function of authorizations which are dependent on user groups. For example, a doctor's pass is read in as an identification and allows the ordering process to take place only when this is in conjunction with the reading in of the medicament information. It is thus possible to initiate ordering processes classified on the basis of authorization levels. If appropriate, an order can be confirmed, and thus finally initiated, by a menu item, which is made available for selection in the software of the mobile appliance. In principle, however, ordering can also be initiated by the user without any further manual actions.

A corresponding situation applies to monitoring processes and billing processes, for example such that the receipt of new medicaments in the medicament room or in a patient's room is monitored, and a medical service is associated with a patient, and is stored in the administration system. Virtually all of the data traffic which makes up the daily procedures in a hospital can thus be carried out without any contact via the mobile appliance and the RFID systems, possibly using a central hospital information system and further information sources.

The computer apparatus can be designed to associate a delivery address for a medicament when an ordering process is initiated, as a function of the reading of at least one further electronically legible identification. For example, this means that it is possible to read the electronic identification of a patient room actively or passively for a medicament order, resulting in the medicament order being delivered directly to this patient's room. The identification of the medicament room of a station or of some other service area within the hospital can likewise preferably be read in automatically for identification. Identifications such as these may be located at the room door or else in the vicinity of an emergency call or emergency system, or the like, which exists in any case.

The mobile appliance may be a handheld computer, including but not limited to a personal digital assistant for example; and/or a communication appliance including but not limited to a mobile telephone for example; and/or a portable personal computer including but not limited to a tablet PC for example. Electronic appliances which have further functionalities or which are carried by users in any case are thus advantageously used as mobile appliances. The enumerated items should be understood as being only examples, and in principle all electronic appliances which are portable and can be provided with reading devices for the electronic identifications are suitable for this purpose.

The mobile appliance may have a programming device or mechanism and an associated indication unit (output unit) including but not limited to a display, for interaction with the user, in particular for the provision of information and/or for the storage of information, and/or for the initiation of processes.

In principle, a voice output is also suitable as an indication unit, but in this case the combination with a graphic display or a text-based display is nevertheless preferable, since information can be remembered more easily when combined with a visual display. The software which runs on the mobile appliance or is provided for it from a central memory may be configured interactively, so that the user can call up further information relating to a specific medicament, relating to a patient or relating to possible processes, such as ordering and the like. Furthermore, in the course of interaction, it is possible to input further information, for example relating to the state of health of a patient or the occurrence of side effects of a medicament.

The mobile appliance may have an input device including but not limited to a voice input device and/or a keypad and/or a touch-sensitive display, etc. These and other input devices allow the user to interact with the programming mechanism of the mobile appliance. Other input devices or techniques that are not mentioned here are, of course, likewise feasible.

In addition, as stated in the introduction, at least one embodiment of the invention relates to a method for access to at least one information item which relates to at least one medicament, in particular via a device as described in the above text, by a user, in particular in a hospital, which method is characterized in that the user carries a mobile electronic appliance with a reading device for reading an electronically legible identification, which identifies the medicament, by which appliance the user makes use of a data link to access information which is related to the medicament and is stored in at least one appliance-internal and/or -external memory device, in such a manner that this information is made available to the user via the mobile appliance as a function of the reading of the electronically legible identification of the medicament.

The user can use the data link to access a computer apparatus with an external memory device, in particular to access at least one central server with a central memory device and/or workstation computer. The user can use the data link, which expediently does not make use of cables, to access an in particular central memory device and/or computer apparatus, which are part of an appliance-external information system and/or a procedure control, in particular part of a hospital information system.

Thus, according to at least one embodiment of the invention, a medicament identification for one or more medicaments is read in, in response to which the data that has been read in is transferred with the aid of the mobile appliance to a memory device, in particular to a central computer apparatus. The memory may be that of an information system which runs on a central server. The transfer takes place using wire-free information techniques, for example in the context of a WLAN system, possibly in conjunction with an at least partially cable-based network. RFID tags, which can be read without contact being made, are advantageously used as identifications.

Furthermore, at least one further electronically legible identification, which is associated with the user and/or with a patient and/or with a location or which is provided with such an association, can be read electronically by the reading device of the mobile appliance, with the user and/or a patient and/or a location being identified, and/or associated with a group, by means of the identification. By way of example, the doctor's pass or an employee pass may be read in in this way, as a result of which the doctor or employee may be identified and, if appropriate, may be provided with authorizations for access to a hospital information system.

The information relating to the medicament can be made available to the user as a function of the reading of the further electronic identification, that is to say by way of example as a function of his position or as a function of the patient for whom the medication in question is being provided. For example, this allows warnings to be emitted if a medicament which is not suitable for patients with a specific illness is read in together with the electronic identification of a patient who currently has this illness, for example diabetes.

The electronically legible identification and/or, if required, further electronically legible identifications can be read, in particular automatically, with contact with the reading device and/or without any contact. Non-contact in reading, for example RFID transponders are particularly suitable for a rapid procedure, requiring no pro-active action by a user, but being carried out automatically.

Reading-related data can be recorded in particular continuously in at least one memory device and/or possibly the computer apparatus, in particular by association of a time stamp and/or reading-related data can be processed further, in particular by linking of data and/or of inputs to the mobile appliance and/or stored data and/or information. It is thus possible to check at any time who has carried out and initiated what process at what location. In particular, this allows monitoring of orders of medicaments and the like.

A computer apparatus can be used to initiate medicament-related processes, in particular ordering processes and/or monitoring processes and/or billing processes, and/or information can be stored in the memory device, as a function of the reading of at least one electronically legible identification, in particular of a user. For example, it is thus possible to reorder a medicament more or less automatically, and possibly after confirmation by a doctor. It is likewise possible to store information in the memory device, for example relating to the occurrence of a rare incompatibility, in which case this information can if required be gathered and processed centrally in order in this way to allow better treatment of further patients as well.

The medicament-related processes can be initiated as a function of authorizations which are determined by the reading of electronically legible identifications, in particular as a function of authorizations which are dependent on user groups. For example, this allows orders to be transmitted to a central computer with a few manual inputs, or without any manual inputs at all, with the central computer initiating a delivery as a function of the patient identification. In addition, when an ordering process for a medicament is initiated, the computer apparatus can associate this with delivery address as a function of the reading of at least one further electronically legible identification, for example of a location.

The mobile appliance uses a programming device/mechanism and an associated indication unit, in particular a display, to interact with the user, in particular by making available information and/or by the storage of information and/or by the initiation of processes.

The method according to at least one embodiment of the invention for information access allows the desired or required information to be obtained quickly and without errors, with few manual actions, or without any manual actions at all. Furthermore, further processes and/or functions can be initiated by reading the electronic identification of the medicament and other electronic identifications. For example, this makes it possible to check the processes being carried out in a hospital, with regard to cost optimization for treatments, as well as easily understandable treatments via automatic recording. This allows the quality of the medication and hence the overall treatment of a patient to be improved, in particular by the rapid and clear provision of information.

Manual data inputs can largely be avoided, so that there is no need for some of the previously provided input and documentation apparatuses. For example, a medicament can be ordered virtually completely automatically, if the order data is passed on via a central hospital information system to, for example, a hospital pharmacy, in which a robot or the like prepares the medicament. Errors and misuse are largely prevented by the continuous checking of identifications, by reading in electronic identifications. Furthermore, once a medicament has been delivered, the mobile appliance can be used to quickly check whether this is actually the correct medicament, in the correct dosage, and whether this complies with the quality requirements.

### BRIEF DESCRIPTION OF THE DRAWINGS

Further advantages, features and details of the invention will become evident from the following example embodiments and from the drawings, in which:

FIG. 1 shows a device according to an embodiment of the invention,

FIG. 2 shows a mobile appliance with information indications,

FIG. 3 shows the procedure for a method according to an embodiment of the invention, and

FIG. 4 shows an outline sketch relating to how a method according to an embodiment of the invention is carried out in a hospital.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

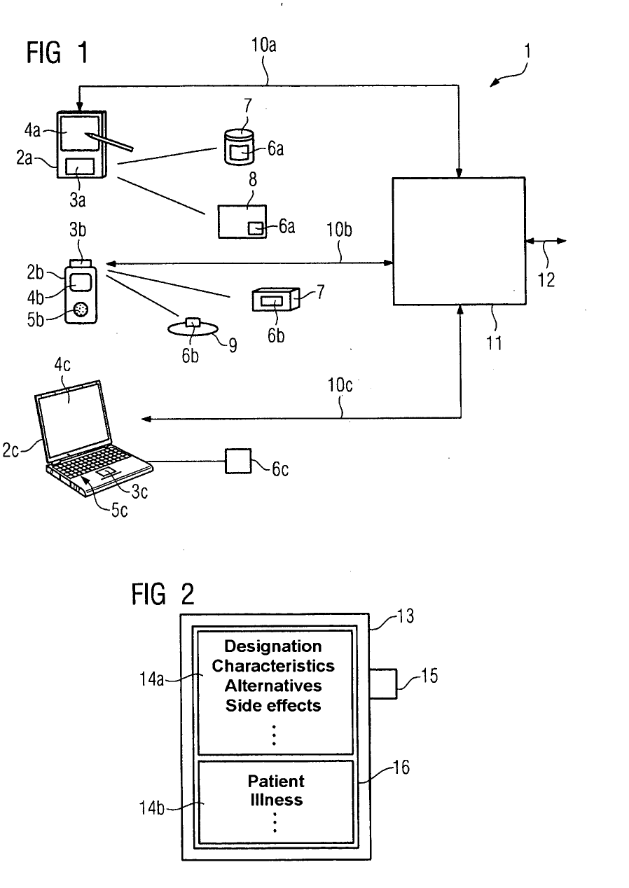

FIG. 1 illustrates a device 1 according to an embodiment of the invention, which has various mobile appliances 2a, 2b and 2c, which are each provided with reading devices 3a, 3b, 3c, which are shown only in the form of sketches here, for electronically legible identifications. Furthermore, the mobile appliances 2a, 2b and 2c have indication units 4a, 4b and 4c, which are in the form of displays and are used to display information, or as an interface of a programming device/mechanism. The mobile appliance 2b also has a voice input device 5b, while the mobile appliance 2c has a keypad 5c. The mobile appliance 2a is in the form of a PDA, the mobile appliance 2b is in the form of a communication appliance, and the mobile appliance 2c is in the form of a portable personal computer.

The reading devices 3a, 3b and 3c for the mobile appliances 2a, 2b and 2c make them suitable for reading electronically legible identifications 6a, 6b and 6c, respectively, which, in chip form or as stickers and passes, are associated with medicaments 7 or, in the form of a pass 8 or armband 9 for example, identify a doctor or a patient. The electronically legible identification 6c is associated with a specific location.

If, for example, the electronically legible identifications 6a for medicament 7 and of the pass 8 are now read in, then a data contact is established, via a data link 10a which does not use cables, between the mobile appliance 2a and a central computer apparatus 11 of the facility 1 with a memory device, which is not illustrated here. Information which relates to the medicament is stored in the computer apparatus 11. Furthermore, an information system in which information relating to user authorizations, that is to say for the user who is carrying the pass 8 as well, is stored, is located on the central computer apparatus 11. If the authorization that is required for this purpose exists, the information which is relevant to the user with the pass 8 and relating to the medicament 7 is displayed on this user's mobile appliance 2a.

Similar data links 10b and 10c, respectively, which do not make use of cables exist to further mobile appliances 2b and 2c and to the appliances and devices which are not illustrated here, as indicated by the double-headed arrow 12.

If, for example, the reading device 3b of the mobile appliance 2b now automatically receives the electronically legible identification 6b of the armband 9 of a patient in conjunction with reading in the electronically legible identification 6b of the medicament 7 in this patient's room, then an ordering process for that medicament can be initiated, if appropriate supported by a voice input, via the voice input device 5b of the mobile appliance 2b, with the information data relating to the medicament 7 being displayed, processed for the relevant patient who is wearing the armband 9, first of all to the user of the mobile appliance 2b. All of these processes are recorded in the computer apparatus 11 in the facility 1, so that, for example, the work of a user in a doctor's room which is provided with the electronic identification 6c can likewise be covered. This allows continuous recording, together with error-free display, processed for the user, of medicament-related information by means of the facility 1 according to the invention, largely without any active action by users.

FIG. 2 shows a mobile appliance 13 with information indications 14a, 14b. The mobile appliance 13 has a reading device 15 for electronically legible identifications. When an electronic identification, which identifies a medicament, is read in by means of the reading device 15, then the information is made available by means of the information indication 14a on the display 16, as a function of the information being called up from a memory device of the mobile appliance 13, or from a central computer apparatus. The information indication 14a displays not only the designation of the medicament but also its characteristics, alternative medications and side effects, as well as further information which is relevant for the user.

Furthermore, as a result of the reading device 15 reading an electronic identification which is related to a patient, the patient information is displayed on the information indication 14b, with this information relating to the name of the patient, his illness, etc.

Furthermore, if this is desired, the information on the information indications 14a, 14b is filtered via a link between the two identifications which have been read in for the medicament and for the patient, so that only that information which is relevant for that particular patient is displayed, for example, with regard to that medicament. An appropriate preselection or selection can be made for this purpose on the mobile appliance 13. The display 16 is touch-sensitive, so that, if appropriate, a user can select specific menu items for further information and for initiation of processes.

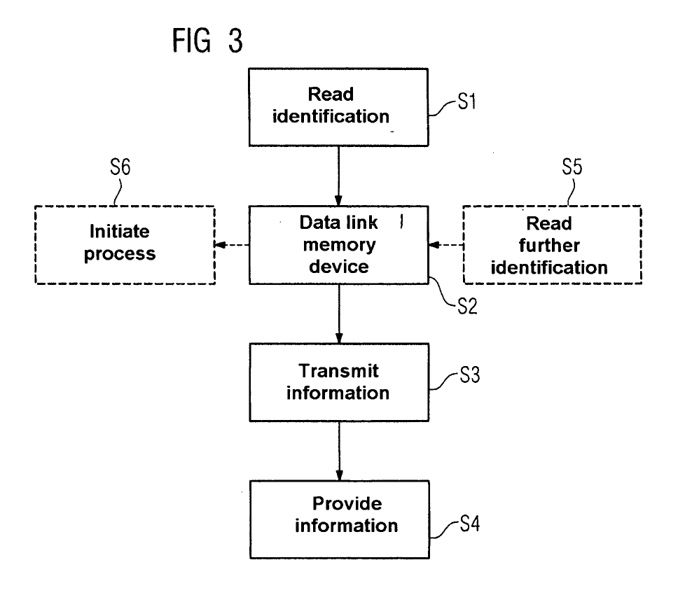

FIG. 3 shows the principle of the procedure for a method according to an embodiment of the invention. In this case, first of all, an electronically legible identification is read in step S1 by a mobile appliance which a user is carrying or which is located in his access area. In step S2, access to information which is associated with the medicament that has been identified by the identification is made possible via a data link to an appliance-internal or -external memory device. This information is transmitted in step S3 to the indication unit and/or to the mobile appliance, so that it is made available to the user, for his information, in step S4. In addition, as shown in step S5, further identifications of the user, of a patient or of a location can be read in. These identifications may relate to active subscribers, that is to say for example a doctor, or passive subscribers in the method, such as locations or patients. Processes as illustrated in step S6 can be initiated as a function of the reading of the further identification on the basis of step S5, which is optional for the method according to an embodiment of the invention, as indicated here by the dashed lines on the illustration. These relate to ordering processes or monitoring processes, or else billing processes which relate to the working procedure in a clinical facility.

The method according to an embodiment of the invention allows access to information, as well as further processing of data which is associated with the reading of electronically legible identifications of medicaments and further subscribers to the method, while largely avoiding manual processes.

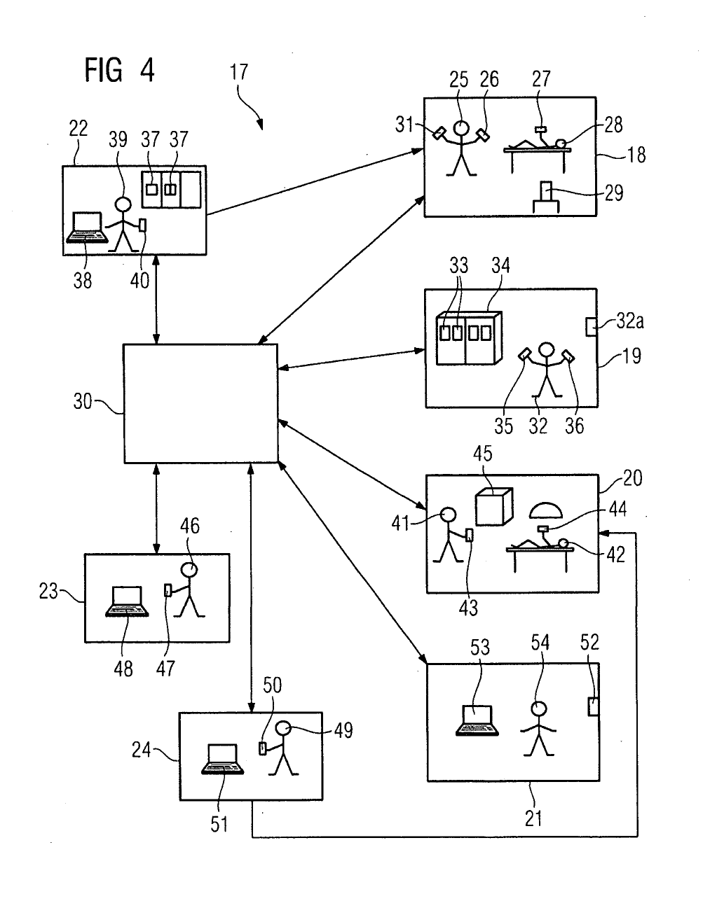

FIG. 4 shows an outline sketch illustrating how a method according to an embodiment of the invention is carried out in a hospital 17. The hospital 17 has patient rooms 18, medicament rooms 19 as well as treatment rooms 20. Doctor's rooms 21, a central pharmacy 22 as well as administration areas 23 and service areas 24 are also provided.

A doctor 25 who is carrying a mobile appliance 26 with him reads in an electronic identification 27, which is in the form of an RFID transponder, for a patient 28 in a patient room 18, without any active action. In addition, an electronic identification 29 of a medicament is read in, with information about this medicament being available in the central computer apparatus 30. This information is filtered as a function of the information which relates to the patient 28 and is likewise available in the central computer apparatus 30, and is displayed to the doctor 25 on his mobile appliance 26, provided that the electronic legible identification 31 which identifies the doctor 25 and is likewise based on RFID technology shows that this doctor 25 has the necessary authorizations for this. The reading-in processes are recorded completely in the central computer apparatus 30.

The medicament room 19 has a location-related electronic identification 32a which makes it possible for a user 32 who is located there to initiate ordering processes for medicaments for which there is no stock or for which the stock is inadequate, with the aid of his mobile appliance 35 and his authorization pass 38, as a function of the reading of the electronic identifications 33 of the medicaments of the medicament cabinet 34. For this purpose, the data is transferred via the central computer apparatus 30 to the pharmacy 22, in which the required medicaments 37 are themselves located, with electronically legible identifications. The electronically legible identifications of the medicaments 37 are read in via a computer device 38 in the form of a workstation computer and as a function of the authorization of the pharmacist 39, who himself carries an electronic identification 40 with him, and is delivered to the delivery address as predetermined by reading in the electronic identification 32a. Deliveries can likewise be made to the patient 28 in his patient room.

A medical technical assistant 41 who is carrying out an examination on a patient 42 is located in a treatment room 20. The medical technical assistant 41 and the patient 42 carry electronically legible identifications 43 and 44 which are read in by a computer device 45 and are transferred to the computer apparatus 30 with information relating to the examination being carried out, in response to which patient-related billing for the service carried out takes place in the administration area 23, by an administration employee 46 with an electronic identification 47, with the aid of a portable computer 48.

Furthermore, there is a link from the computer apparatus 30 to the service area 24 in which an employee 49 with an electronic identification 50 carries out service tasks on a computer device 51, for example in order to deliver a desired medicament quickly when required, or to investigate technical problems. A location-related electronically legible identification 52 is once again located in the doctor's room 21 and, with the aid of the reading device of the mobile appliance 53, makes it possible to determine where a doctor 54 is currently located, with this doctor being identified in this case by biometric features.

The method according to an embodiment of the invention therefore not only allows medicament-related information to be obtained and displayed quickly and matched to the respective user and/or the relevant patient but, via a link to a computer apparatus, it is also possible to initiate and document a large number of further processes, such as reordering and billing. The use of electronically legible identifications on medicaments and for further active and passive subscribers to the method makes it possible to record and to optimize the procedures in a hospital, without major effort.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDS; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A device for access to at least one information item, which is related to at least one medicament, by a user, comprising:
at least one mobile electronic appliance, to be carried by the user, the at least one mobile electronic appliance including
a reading device for reading an electronically legible identification which identifies the medicament,
a data link to at least one appliance-internal and/or -external memory device in which the information item relating to the medicament is stored so as to be made available to the user via the mobile appliance as a function of the reading of electronically legible identification of the medicament, wherein medicament-related processes are initiateable via a computer apparatus as a function of the reading of at least one electronic identification and wherein the medicament-related processes are initiateable as a function of authorizations determined by the reading of electronically legible identifications.

2. The device as claimed in claim 1, further comprising a computer apparatus, with an external memory device.

3. The device as claimed in claim 1, wherein at least one of the central memory device and computer apparatus is part of at least one of an appliance-external information system and procedure control.

4. The device as claimed in claim 1, wherein at least one of
at least one of the user, a patient and a location has at least one further associated identification to be read electronically by the reading device of the mobile appliance, and
at least one of the user, the patient and the location is provided with such an identification,
and wherein the at least one of the user, the patient and the location are at least one of identifiable and associateable with a group via the identification.

5. The device as claimed in claim 4, wherein the information is made available to the user as a function of the reading of the further electronic identification.

6. The device as claimed in claim 1, wherein the electronically legible identification is at least one of a barcode, an RFID transponder and a further identification which is readable without contact being made.

7. The device as claimed in claim 1, wherein at least one electronically legible identification is in the form of at least one of a label, a chip and an identification device which is at least one of wearable and carryable on the body.

8. The device as claimed in claim 1, wherein at least one memory device is designed for at least one of continuous recording of reading-related data and further processing of reading-related data.

9. The device as claimed in claim 1, wherein information is storable in the memory device via a computer apparatus as a function of the reading of at least one electronic identification.

10. The device as claimed in claim 1, wherein, on initiation of an ordering process for a medicament, the computer apparatus is designed to allocate a delivery address as a function of the reading of at least one further electronically legible identification.

11. The device as claimed in claim 1, wherein the mobile appliance is at least one of a handheld computer, a communication appliance, and a portable personal computer.

12. The device as claimed in claim 1, wherein the mobile appliance includes a programming device and an associated indication unit for interaction with the user.

13. The device as claimed in claim 1, wherein the mobile appliance includes at least one of a voice input device, a keypad and a touch-sensitive display.

14. A method for access to at least one information item which is related to at least one medicament by a user, the user carrying a mobile electronic appliance, the method comprising:
reading an electronically legible identification which identifies the medicament, using the mobile electronic appliance;
using a data link, via the mobile electronic appliance, to access the at least one information item which is related to the at least one medicament and stored in at least one memory device, the at least one information item being made available to the user as a function of the reading of the electronically legible identification of the medicament via the mobile appliance,
initiating medicament-related processes via a computer apparatus at least one of as a function of the reading of at least one electronically legible identification and as a function of authorizations determinable by the reading of electronically legible identifications.

15. The method as claimed in claim 14, wherein the user uses the data link to access a computer apparatus having an external memory device.

16. The method as claimed in one of claims 14, wherein the user uses the data link to access an at least one of a central memory device and computer apparatus, which are part of at least one of an appliance-external information system and procedure control.

17. The method as claimed in claim 14, wherein at least one further electronically legible identification, at least one of associated with at least one of the user, a patient and a location and provided with such an identification, is read electronically by the reading device of the mobile appliance, with the at least one of the user, the patient and the location being at least one of identified and associated with a group via the identification.

18. The method as claimed in claim 17, wherein the information is made available to the user as a function of the reading of the further electronic identification.

19. The method as claimed in claim 14, wherein the electronically legible identification is read at least one of by contact with the reading device and without contact being made.

20. The method as claimed in claim 14, wherein reading-related data is recorded in at least one memory device.

21. The method as claimed in claim 14, wherein information is stored in the memory device as a function of the reading of at least one electronically legible identification.

22. The method as claimed in claim 14, wherein, on initiation of an ordering process for a medicament, the computer apparatus allocates a delivery address as a function of the reading of at least one further electronically legible identification.

23. The method as claimed in claim 14, wherein the mobile appliance interacts with the user via a programming device and an associated indication unit.

24. The device as claimed in claim 1, wherein the medicament-related processes include at least one of ordering processes, monitoring processes and billing processes.

25. The device as claimed in claim 1, wherein the medicament-related processes are initiateable as a function of authorizations which are dependent on user groups.

26. The device as claimed in claim 2, wherein the computer apparatus includes at least one of a central server and a workstation computer.

27. The device as claimed in claim 3, wherein the appliance-external information system is part of a hospital information system.

28. The device as claimed in claim 7, wherein at least one electronically legible identification is in the form of at least one of a pass and armband.

29. The device as claimed in claim 11, wherein the handheld computer is a personal digital assistant, the communication appliance is a mobile telephone, and the portable personal computer is a tablet PC.

30. The device as claimed in claim 12, wherein the associated indication unit is a display and wherein the interaction with the user includes at least one of the provision of information, the storage of information and the initiation of processes.

31. The method as claimed in claim 14, wherein the medicament-related processes include at least one of ordering processes, monitoring processes and billing processes.

32. The method as claimed in claim 14, wherein the medicament-related processes are initiateable as a function of authorizations which are dependent on user groups.

33. The method as claimed in claim 16, wherein the appliance-external information system is part of a hospital information system.
